(19) United States
(12) Patent Application Publication
(10) Pub. No.: US 2014/0215986 A1
(43) Pub. Date: Aug. 7, 2014

(54) Induction Reel Motor

(71) Applicant: TEXTRON INC., Providence, RI (US)

(72) Inventor: Stephen F. KOVACS, II, Rock Hill, SC (US)

(73) Assignee: Textron Inc., Providence, RI (US)

(21) Appl. No.: 13/760,126

(22) Filed: Feb. 6, 2013

(51) Int. Cl. A01D 34/58; A01D 34/43

(52) U.S. Cl. CPC A01D 34/58; A01D 34/43
USPC 56/10.7; 56/16.7

(57) ABSTRACT

An induction motor system for a reel assembly of a turf maintenance vehicle includes a frame and a turf maintenance implement assembly defining a reel assembly movably connected to the frame. The reel assembly includes multiple reel blades defining a reel blade assembly. The reel blade assembly is rotatably connected to a structure of the reel assembly. Multiple induction coils are connected to the structure of the reel assembly and energized to create a magnetic field through the reel blades of the reel blade assembly thereby inducing rotation of the reel blade assembly.

### FIELD

The present disclosure relates to an induction system motor and method for operating a reel mower.

### BACKGROUND

This section provides background information related to the present disclosure which is not necessarily prior art.

Reel mower decks are used in grass cutting machines where a fine cut or consistent grass cut height are desirable, and therefore are often used in lawn cutting machines on golf courses and in public areas. Commonly known methods to drive reel mower assemblies include electric or hydraulic motors that are mounted at one or both opposing ends of the reel deck that directly or indirectly rotate a centrally disposed reel drive rod to which the individual reel blades are connected.

Having externally mounted electric or hydraulic motors adds significant width and weight to the reel deck assembly which creates several problems. During cutting operation, the space envelope of an externally mounted motor increases the minimum clearance required between the deck assembly and objects such as shrubs, trees, fences, and the like, such that the reel blades may not be able to cut as close to these objects as desired. Protective cages added to prevent damage to the motors further exacerbates this situation. The weight of a single motor mounted to only one side of a deck assembly can also create an alignment imbalance, which is commonly corrected by adding a counterbalanced weight to the opposite deck side, thereby unnecessarily adding weight and cost to the assembly.

### SUMMARY

This section provides a general summary of the disclosure, and is not a comprehensive disclosure of its full scope or all of its features.

According to several aspects, an induction motor system for a reel assembly includes a reel blade assembly including multiple reel blades. The reel blade assembly is rotatably connected to a structure of a reel assembly. At least one linear induction coil is connected to the reel assembly and when energized creates a magnetic field through the reel blades thereby inducing rotation of the reel blade assembly.

According to other aspects, an induction motor system for a reel assembly of a turf maintenance vehicle includes a frame and a turf maintenance implement assembly defining a reel assembly movably connected to the frame. The reel assembly includes multiple reel blades defining a reel blade assembly. The reel blade assembly is rotatably connected to a structure of the reel assembly. Multiple induction coils are connected to the structure of the reel assembly and energized to create a magnetic field through the reel blades of the reel blade assembly thereby inducing rotation of the reel blade assembly.

According to further aspects, an induction motor system for a reel assembly of a turf maintenance vehicle includes a frame and a turf maintenance implement assembly defining a reel assembly movably connected to the frame. The reel assembly includes multiple reel blades defining a reel blade assembly. The reel blade assembly is rotatably connected to a structure of the reel assembly. Multiple induction coils are connected to the structure of the reel assembly and energized to create a magnetic field through the reel blades of the reel blade assembly thereby inducing rotation of the reel blade assembly.

According to still further aspects a method for operating a reel assembly of a turf maintenance vehicle is provided.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front left perspective view of a powered turf maintenance vehicle having induction reel motors driving multiple reel assemblies;

FIG. 2 is a front left perspective view of area 2 of FIG. 1;

FIG. 3 is a front end elevational view of one of the reel assemblies having induction reel motors of FIG. 1;

FIG. 4 is a cross sectional end elevational view taken at section 4 of FIG. 3; and

FIG. 5 is a right end elevational view of the reel assembly of FIG. 3.

Corresponding reference numerals indicate corresponding parts throughout the several views of the drawings.

### DETAILED DESCRIPTION

Example embodiments will now be described more fully with reference to the accompanying drawings.

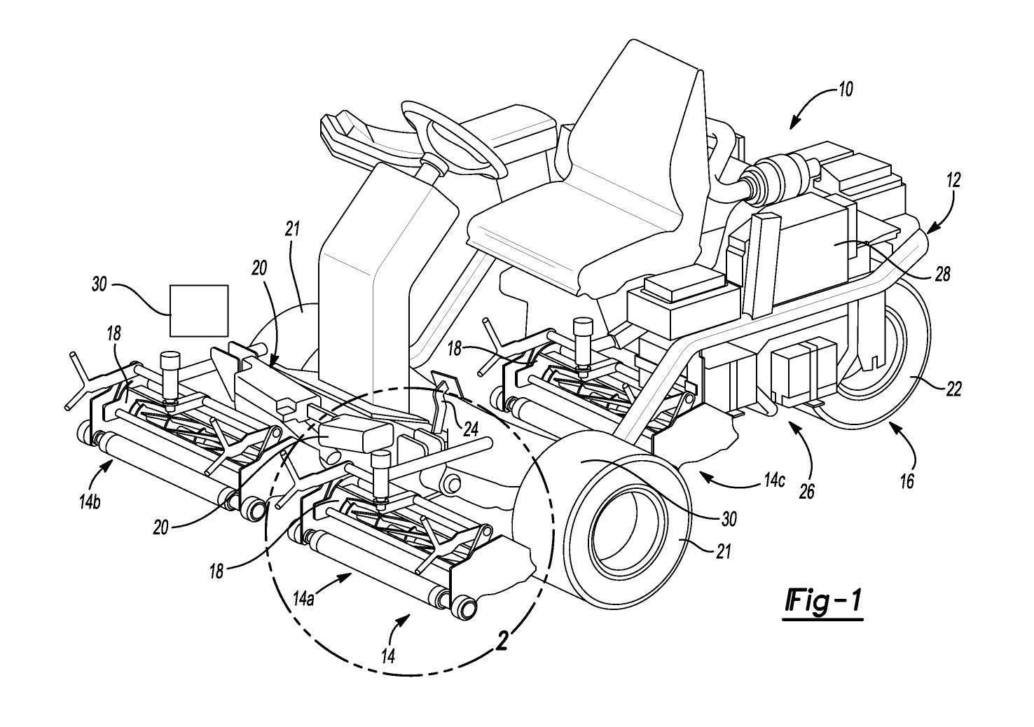

Referring to FIG. 1, a turf maintenance vehicle (i.e., a grounds keeping vehicle), such as a turf maintenance vehicle 10 is illustrated. In the embodiment shown, turf maintenance vehicle 10 is a riding mower that generally includes a frame 12, one or more turf maintenance implement assemblies 14 which according to several aspects are reel assemblies, and a ground traction system generally indicated at 16. It will be understood by one skilled in the art that the teachings herein are applicable to any suitable turf maintenance vehicle, including, by way of non-limiting example, riding mowers, walk-behind mowers, stand behind mowers, and other turf maintenance equipment.

Turf maintenance implement assemblies 14 are supported by the frame 12 and can be of any suitable type for turf or golf course maintenance purposes, and can include a cutting unit 18, shown herein as a reel cutter for cutting grass. Turf maintenance implement assemblies 14 are raised and lowered by a respective lift mechanism 20. In various embodiments, turf maintenance assembly implements 14 may include one or a plurality of implements, such as a pair of forward turf maintenance implement assemblies 14a, 14b and a rear or center turf maintenance implement assembly 14c.

Ground traction system 16 supports frame 12 and provides propulsion and steering for turf maintenance vehicle 10. In various embodiments, ground traction system 16 includes a plurality of front wheels 21, which are driven to propel turf maintenance vehicle 10, and a rear wheel 22, which can turn relative to frame 12 to thereby steer turf maintenance vehicle 10. The ground traction system 16 also includes a brake 24 which can be of any suitable type for reducing the ground speed of turf maintenance vehicle 10.

Turf maintenance vehicle 10 includes a power delivery system generally indicated at 26. Power delivery system 26 can be of any suitable type for generating power and transmitting power to the ground traction system 16 and/or the turf maintenance implement assemblies 14. For example, power delivery system 26 can include an internal combustion engine for generating mechanical or electrical energy, a plurality of batteries, or a combination of the two. As such, power delivery system 26 generates and delivers power to ground traction system 16 to thereby propel the mower. In various embodiments, power delivery system 26 further includes a generator 28 which delivers electrical power at least to energize turf maintenance implement assemblies 14. According to several aspects, generator 28 can provide 3 phase electrical power.

In various embodiments one or a plurality of position sensors, shown schematically in FIG.1 as position sensor 30 may be associated with each of the turf maintenance implement assemblies 14. Position sensors 30 can be used to signal a ground engaged or a stowed position for each of the turf maintenance implement assemblies 14. This sensed position can be used for example to isolate electrical power to the turf maintenance implement assemblies 14 when in the stowed position. In other embodiments, position sensor 30 can be a single position sensor associated with all turf maintenance implement assemblies 14.

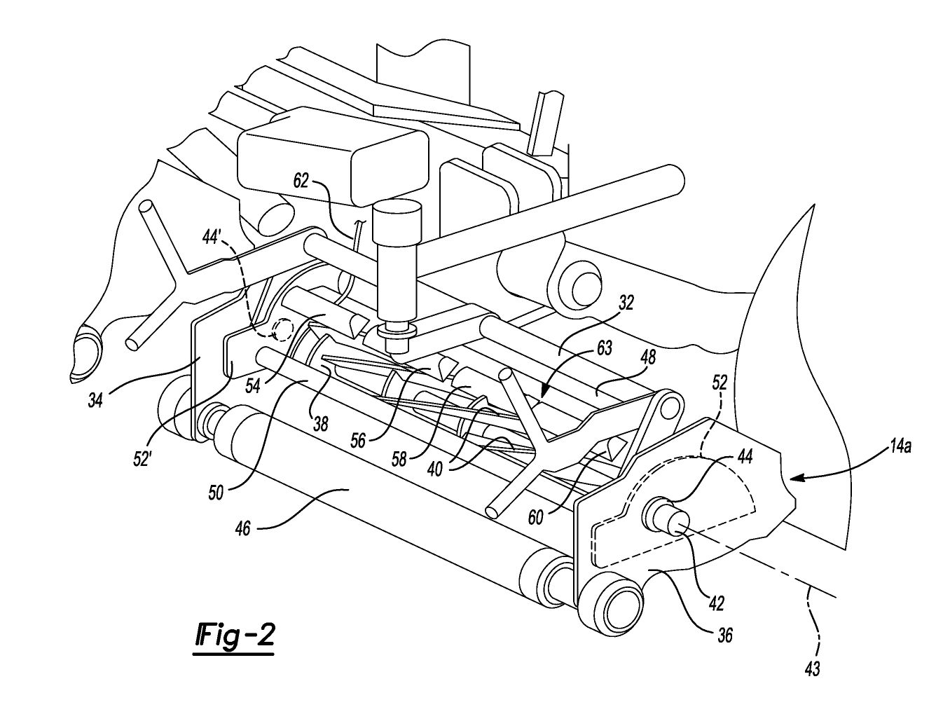

Referring to FIG. 2 and again to FIG. 1, turf maintenance implement assembly 14a is shown in greater detail, and is representative of the other turf maintenance implement assemblies 14b, 14c which are not shown for clarity. Turf maintenance implement assembly 14a includes a positioning mechanism 32 to raise and lower the assembly. Opposed first and second end members 34, 36 such as metal plates or formed members rotatably support a reel blade assembly 38 there-between which includes multiple helical-shaped cutting members as reel blades 40. The reel blades 40 are connected to a central longitudinal shaft 42 which is connected for rotation with respect to a longitudinal axis 43 to bearing or journal members 44, 44′. The journal members 44, 44′ are each connected to one of the first or second end members 34, 36. A support roller 46 can also be rotatably connected at opposed ends to first and second end members 34, 36. Further known implements (not shown for clarity) such as but not limited to flail cutting implements, grooming implements, raking implements, aerating implements, and other turf maintenance implements can also be provided with turf maintenance implement assembly 14a.

To provide additional lateral support and stiffness, first and second cross members 48, 50 such as covers, bars or plates are each fixedly connected at opposed ends to one of the first or second end members 34, 36 and/or to opposed stiffening plates 52, 52′ (only stiffening plate 52′ is clearly visible in this view) which are fixed to individual ones of the first or second end members 34, 36. At least one and according to several aspects multiple linear induction coils 54, 56, 58, 60 are supported by one of the first or second cross members 48, 50. Each linear induction coil 54, 56, 58, 60 receives 3 phase electrical power via a power lead 62 which is connected to generator 28. By sequentially energizing linear induction coils 54, 56, 58, 60 a magnetic field is created through reel blades 40 which induces rotation of reel blade assembly 38. A rotational speed of reel blade assembly 38 can be controlled for example by a frequency of energizing the linear induction coils 54, 56, 58, 60 and/or a current flow.

The linear induction coils 54, 56, 58, 60 are all positioned entirely between the first and second end members 34, 36 and therefore do not extend beyond a space envelope of the first and second end members 34, 36. The linear induction coils 54, 56, 58, 60 are each coated with a protective material 63 such as an epoxy or other polymeric material to withstand impact from objects encountered during normal operation of reel blades 40 such as dirt, stones, twigs and the like.

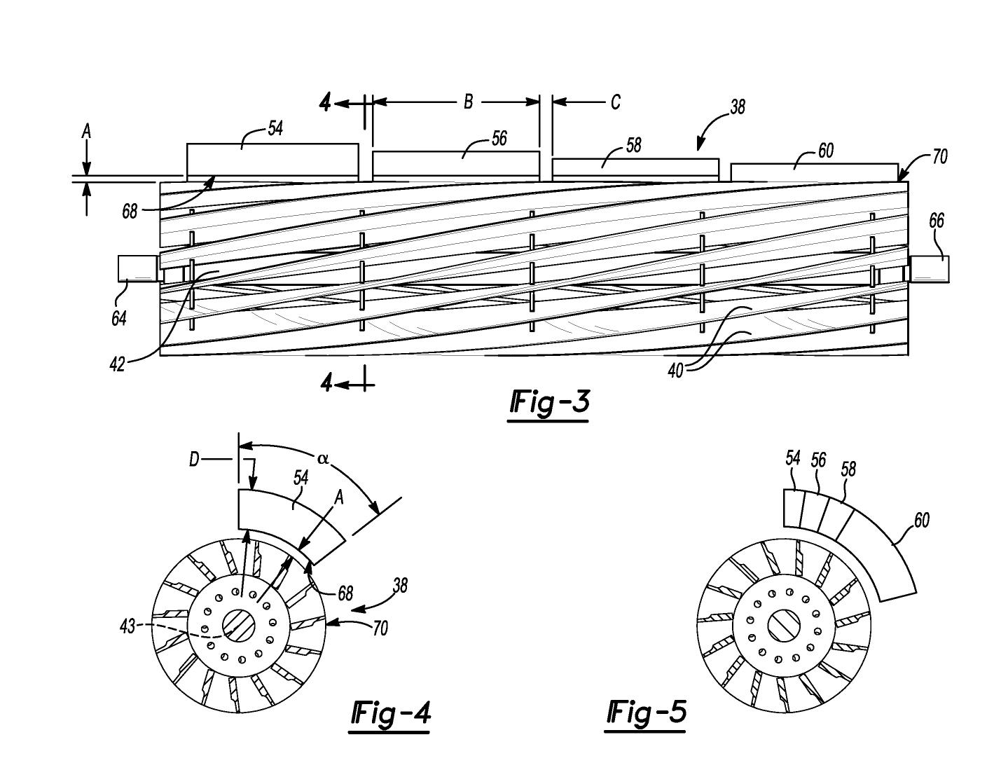

Referring to FIG. 3 and again to FIGS. 1 and 2, because the shaft 42 of reel blade assembly 38 is not itself directly driven or powered such as by belts, gears, or direct motor drive, opposed first and second bearing ends 64, 66 are provided which are passively rotatably seated in journal members 44, 44′. Each of the linear induction coils 54, 56, 58, 60 includes a curved inner surface 68 which mimics a curvature of reel blades 40 at an outer perimeter 70 of the reel blades 40 such that curved inner surface 68 is equally spaced at all locations from an outer edge of reel blades 40 defined by outer perimeter 70. To maintain a consistent magnetic field, a predetermined spacing “A” is maintained between each inner surface 68 of the linear induction coils 54, 56, 58, 60 and the outer edge of the reel blades 40 defining the outer perimeter 70. According to several aspects, a radius of curvature of each inner surface 68 is equal to a radius of the reel blade assembly 38 plus predetermined spacing “A”. According to several aspects predetermined spacing “A” is set at approximately 0.25 in or less. According to several aspects, a length “B” of each of the linear induction coils 54, 56, 58, 60 is equal, and is determined in part on a total length of the reel blade assembly 38 divided by a quantity of reel induction coils used. According to further aspects, a constant separation distance “C” is also maintained between any two successive ones of the linear induction coils 54, 56, 58, 60. Although four linear induction coils 54, 56, 58, 60 are shown, the disclosure is not limited to this quantity. Fewer than four or more than four linear induction coils can be used within the scope of the present disclosure.

Referring to FIG. 4 and again to FIGS. 1 through 3, the linear induction coils 54, 56, 58, 60 are each semi-circular as viewed with respect to the longitudinal axis 43. The spacing “A” is maintained for an entire surface area defined by curved inner surface 68 with respect to outer perimeter 70. A thickness “D” of each of the linear induction coils 54, 56, 58, 60 is substantially constant throughout the length “B”. An arc defined by an angle alpha (a) with respect to longitudinal axis 43 for each of the linear induction coils 54, 56, 58, 60 is also constant. According to several aspects angle a is approximately 45 degrees.

Referring to FIG. 5 and again to FIGS. 1 through 4, the linear induction coils 54, 56, 58, 60 can also each be sequentially rotationally staggered as viewed in FIG. 4 matching a pitch of the individual reel blades 40. This configuration maximizes the magnetic field interaction with as much of each reel blade 40 as possible during its rotation past the linear induction coils 54, 56, 58, 60.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An induction motor system for a reel assembly, comprising:
a reel blade assembly including multiple reel blades, the reel blade assembly rotatably connected to a structure of a reel assembly; and
at least one linear induction coil connected to the reel assembly energized to create a magnetic field through the reel blades thereby inducing rotation of the reel blade assembly.

2. The induction motor system for a reel assembly of claim 1, wherein the at least one linear induction coil is supported by a cross member of the reel assembly.

3. The induction motor system for a reel assembly of claim 2, wherein the at least one linear induction coil operates using 3 phase electrical power.

4. The induction motor system for a reel assembly of claim 3, wherein the electrical power is provided to the at least one linear induction coil via a power lead connected to generator of a turf maintenance vehicle.

5. The induction motor system for a reel assembly of claim 1, wherein the at least one linear induction coil includes a curved inner surface which mimics a curvature of the reel blades at an outer perimeter of the reel blades.

6. The induction motor system for a reel assembly of claim 5, wherein a predetermined spacing is maintained between the inner surface of the at least one linear induction coil and an outer edge of the reel blades defining the outer perimeter.

7. The induction motor system for a reel assembly of claim 6, wherein the predetermined spacing is approximately 0.25 in or less.

8. The induction motor system for a reel assembly of claim 1, wherein the at least one linear induction coil includes multiple linear induction coils.

9. The induction motor system for a reel assembly of claim 8, wherein:
a length of any of the linear induction coils is equal; and
a constant separation distance is maintained between any two successive ones of the multiple linear induction coils.

10. The induction motor system for a reel assembly of claim 1, wherein the reel blades are connected to a shaft having opposed first and second bearing ends each passively rotatably seated in a journal member connected to the reel assembly.

11. An induction motor system for a reel assembly, comprising:
a reel blade assembly including multiple reel blades, the reel blade assembly rotatably connected to a structure of a reel assembly; and
multiple linear induction coils connected to a member of the reel assembly and energized to create a magnetic field through the reel blades thereby inducing rotation of the reel blade assembly; and
each of the induction coils includes a curved inner surface which mimics a curvature of the reel blades at an outer perimeter of the reel blades.

12. The induction motor system for a reel assembly of claim 11, wherein the linear induction coils are sequentially rotationally staggered to equal a pitch of the individual reel blades.

13. The induction motor system for a reel assembly of claim 11, wherein the linear induction coils are each semi-circular shaped.

14. The induction motor system for a reel assembly of claim 11, wherein a spacing is maintained for an entire surface area defined by the curved inner surface with respect to the outer perimeter.

15. The induction motor system for a reel assembly of claim 11, wherein a thickness of each of the linear induction coils is substantially constant throughout a length of each of the linear induction coils.

16. The induction motor system for a reel assembly of claim 11, wherein each of the linear induction coils defines an arc having an angle determined with respect to a longitudinal axis of the reel blade assembly.

17. The induction motor system for a reel assembly of claim 11, wherein the arc of each of the linear induction coils is constant.

18. An induction motor system for a reel assembly of a turf maintenance vehicle, comprising:
a frame,
a turf maintenance implement assembly defining a reel assembly movably connected to the frame;
the reel assembly including multiple reel blades defining a reel blade assembly, the reel blade assembly rotatably connected to a structure of the reel assembly; and
multiple induction coils connected to the structure of the reel assembly and energized to create a magnetic field through the reel blades of the reel blade assembly thereby inducing rotation of the reel blade assembly.

19. The induction motor system for a reel assembly of a turf maintenance vehicle of claim 18, further including a generator providing electrical power to operate the induction coils.

20. The induction motor system for a reel assembly of a turf maintenance vehicle of claim 19, wherein the generator produces 3-phase electrical power.

21. The induction motor system for a reel assembly of a turf maintenance vehicle of claim 18, wherein each of the induction coils includes a curved inner surface which mimics a curvature of the reel blades at an outer perimeter of the reel blades.

22. The induction motor system for a reel assembly of a turf maintenance vehicle of claim 21, further including a predetermined spacing maintained between the inner surface of each of the induction coils and an outer edge of the reel blades defining the outer perimeter.

23. A method for operating a reel assembly of a turf maintenance vehicle, the reel blade assembly including multiple reel blades, the method comprising:
rotatably connecting the reel blade assembly to a structure of a reel assembly; and
connecting a linear induction coil to the reel assembly; and
energizing the linear induction coil thereby creating a magnetic field through the reel blades to induce rotation of the reel blade assembly.

24. The method of claim 23, further comprising connecting the linear induction coil to a generator providing 3-phase electrical power.

25. The method of claim 23, further comprising maintaining a predetermined spacing between an inner surface of the linear induction coil and an outer edge of the reel blades.
